(19) United States
(12) Patent Application Publication
(10) Pub. No.: US 2007/0045587 A1
(43) Pub. Date: Mar. 1, 2007

(54) Diaphragm valve seat

(76) Inventors: Terrence Kolenc, Mentor, OH (US); Howard Kuhns, Aurora, OH (US); William Glime, Painsville Twp, OH (US); Carl E. Meece, Moreland Hills, OH (US); Gerhard H. Schiroky, Aurora, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/551,480

(22) PCT Filed: Apr. 13, 2004
(86) PCT No.: PCT/US04/11302

§ 371 Date: Sep. 29, 2005

Related U.S. Application Data
(60) Provisional application No. 60/320,105, filed on Apr. 14, 2003.

(51) Int. Cl. F16K 1/00

(52) U.S. Cl. 251/331

(57) ABSTRACT

A thermally and chemically inert valve seat is provided. The valve seat includes a sharp edge located on the periphery of the valve seat body, wherein the edge digs into a surface within the valve body to secure the valve seat. The valve seat may be case hardened to provide additional strength and sealing ability. The inner diameter of the valve seat may be flush against the valve fluid passageway, thereby decreasing the contact area between the diaphragm and the valve seat.

### FIELD OF THE INVENTION

The present invention relates generally to a valve seat for a diaphragm valve, and more particularly to a metal valve seat for a diaphragm valve, and composition and geometry therefor, for withstanding high temperatures and corrosive materials.

### BACKGROUND

Diaphragm valves are generally known and include a valve arrangement wherein a diaphragm seals against an annular valve seat thereby prohibiting the flow of fluid through the valve. As such, the valve seat is used to seal off an inlet or outlet passageway by engaging with the diaphragm. Diaphragms may be made of metal or non-metal materials.

Typical valve seats used with metal diaphragms are designed from a plastic based material, such as polychloro-trifluoro-ethene, polyimide, or Teflon™. However, non-metal valve seats have properties that change when subjected to environmental factors outside the parameters of rated use, such as high or low temperature ranges or when the valve seat is exposed to a highly corrosive material. In such aggressive applications, metal valve seats have been used, however, the performance requirements of such known all-metal valves do not typically match the performance of plastic based valve seats. For example, a valve with a metal valve seat may demonstrates a higher leak rate, a decrease in the number of operable cycles, or an increase in the required actuation force. Decreasing the rated number of cycles is a disadvantage, and this disadvantage is even larger for systems operating at high temperature or regulating a corrosive material as replacement costs can be high. This is because the valve is frequently used to control the flow rate of such materials, thus requiring a dramatic increase in the number of cycles required on a regular basis. As such, it is desirable to provide a valve seat that allows for higher rated temperatures or for controlling corrosive materials without compromising the performance of the valve.

### SUMMARY OF THE INVENTION

A metal valve seat is provided wherein the valve seat is thermally and chemically inert. In one embodiment, the seat is formed as an insert, while in other embodiments the seat may be integral. The seat may optionally include an edge or other protrusion that can penetrate, dig into or otherwise tightly engage a portion of the valve body, thereby securing and sealing the valve seat in place. In another embodiment, the seat is formed such that it is harder than the diaphragm. In one such embodiment, at least some portion of the valve seat is case hardened or optionally through hardened. In one embodiment, the valve insert has an inner diameter that is flush with the diameter of a fluid passageway disposed within the valve body thereby forming a continuous flow path.

Another aspect of the present invention is a method of staking a valve seat insert, in particular a metal valve seat insert. In one embodiment, the valve seat insert includes an edge or protrusion located on the periphery of the valve seat body. The method includes inserting such valve seat into the valve body and clamping a portion of the valve body down on the valve seat, thereby driving the valve seat edge into another portion of the valve body. This method further provides a seal between valve seat and the valve body.

### BRIEF DESCRIPTION OF THE FIGURES

In the accompanying drawings, which are incorporated in and constitute a part of this specification, embodiments of the invention are illustrated, which, together with a general description of the invention given above, and the detailed description given below serve to illustrate the principles of this invention.

FIG. 1 is cross-sectional view of a prior art diaphragm valve having a polymeric valve seat;

FIG. 2 is a cross-sectional view of a diaphragm valve including a metal valve seat insert and a staking apparatus;

FIG. 3 is detailed cross-sectional view of the valve seat insert as shown in FIG. 2;

FIG. 4 is detailed cross-sectional view of the valve seat insert and the seal provided between the valve seat and the diaphragm; and

FIG. 5A-5B are view showing the staking of a metal valve seat employing only the outer stake.

FIG. 6 illustrates a replaceable metal valve seat.

FIG. 7 illustrates an integral metal valve seat.

### DETAILED DESCRIPTION

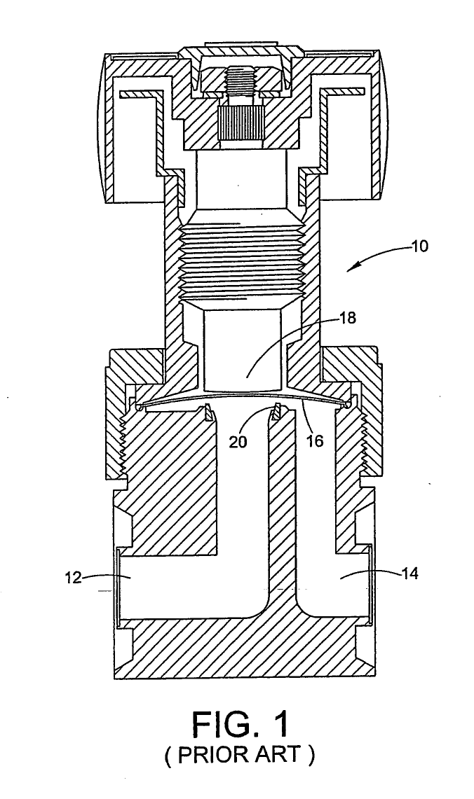

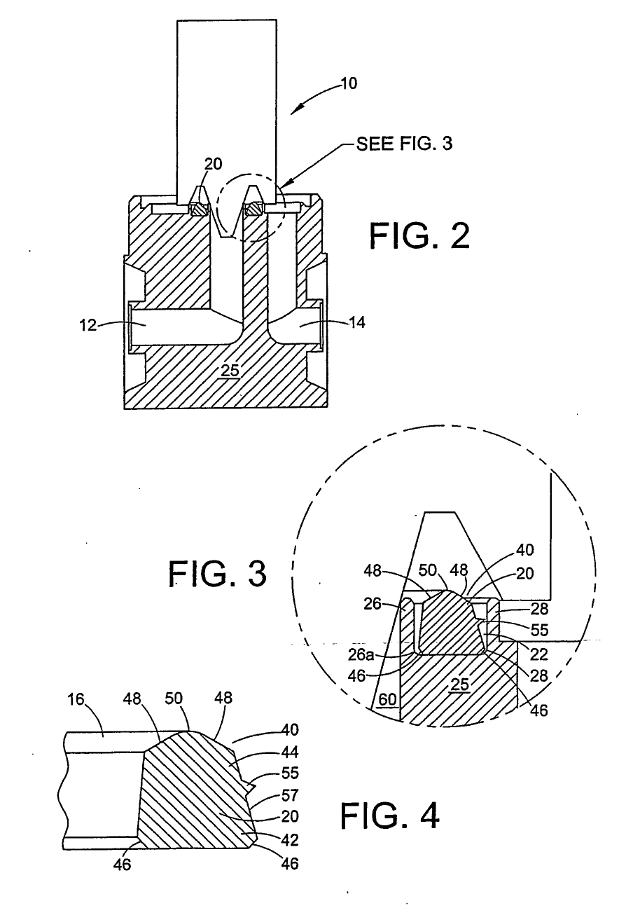

With reference to FIGS. 1, a diaphragm valve 10 is shown having an inlet passageway 12, an outlet passageway 14, a diaphragm 16, an actuator 18 and a polymeric valve seat 20. The remainder of the diaphragm valve 10 is of general construction and can be a variety of different embodiments. These embodiments are not discussed further in this application as they do not pertain to the inventive aspects covered in this application. As such, the scope of this application should not be limited by any additional aspects of the diaphragm valve not specifically discussed herein. The present invention replaces the polymeric valve seat with a metal valve seat, either integrally formed or formed as an insert. In doing so, the valve seat may be hardened to improve cycle life, or, in the case of an insert, may include an alternative staking and sealing means, or may include a combination of these features.

FIG. 3 shows a close-up view of the valve seat 20. As shown, the valve seat 20 is typically a separate component that is placed within a valve seat recess 22 located within the body 25 of the valve 10. The valve seat 20 rests between inner wall 26 and outer wall 28.

A known method of staking a plastic seat such that it is sealed between an inner wall and an outer wall, or valve body portion, is disclosed in commonly assigned, U.S. Pat. No. 6,092,550. Typically, this staking method cannot be used on the metal valve seat 20 since the deformation will not occur as described in the above-referenced patent, and therefore a seal will not be formed between the valve seat and the valve body. As such, the valve seat 20 of the present invention is specially designed to provide a solid stake, thereby avoiding movement in the seat and creating misalignment with the diaphragm. The solid stake also ensures the metal valve seat will seal against the valve body. Furthermore, the valve seat may include a special top surface 40 for good mating contact with the diaphragm.

The valve seat 20, as detailed in FIGS. 3 and 4, is generally annular in nature and tapers from the bottom of the seat 42 to the top of the seat 44. The bottom corners 46 of the seat 20 may be beveled to conform the seat against the inner and outer walls 26 and 28. In particular, the bottom portion of the inner and outer walls 26 and 28 contain radiused or chamfered portions 26a and 28a that cooperate with the beveled portions 46 of the seat 20. The respective beveled portions allow the valve seat to sit flatly in the recess 22 and provides a clearance tolerance for placing the seat within the recess. The top surface 40 has a sloping surface 48 located on either side of the raised sealing surface 50. The raised sealing surface 50 can either be rounded or flat or may be sloped. The configuration of the sealing surface 50 depends on the diaphragm 16 configuration as the contact between the sealing surface and the diaphragm should provide a seal. Preferably, the seal formed between the sealing surface 50 and diaphragm 16 is wider than line contact, i.e. point contact between the sealing surface and diaphragm along a radius of the diaphragm, thereby ensuring a better seal. This can be accomplished by mating the shape of the sealing surface 50 to that of the diaphragm surface.

An optional additional feature of the metal valve seat 20 that assists in the staking and sealing of the valve seat is the edge or protrusion 55 that extends from the outer surface 57 of the valve seat. This edge 55 may be sharp in nature, such that it digs into the surface of the outer wall 28 upon the application of pressure. In some embodiments, however, a less sharp or rounded protrusion 55 can alternatively be used providing it secures the valve seat. The protrusion digs into a portion of the valve body thereby creating a body seal along that surface. Although the embodiment shown in the drawings includes an angled protrusion, such angling is not required. By angling the protrusion, it is easier to engage the protrusion with the valve body wall. Also, the angled protrusion provides a downward force into the valve body, thereby providing force to fully seat the insert into the valve body.

The protrusion 55 may be circumferential, partially circumferential, or can be one or more individual spikes or protrusions. When the outer wall 28 is crimped toward the valve seat 20, the force drives the protrusion 55 into the surface of the outer wall 28 thereby securing the seat 20 within the valve seat recess 22. In other embodiments, a plurality of edges or protrusions 55 are used to secure and seal the valve seat 20. For example, one or more protrusions 55 may be formed to engage the inner wall 26, the outer wall 28, or may be formed on a corner or edge of the valve seat or the bottom surface 27 of the valve seat 20. It is generally preferred to provide the protrusion or protrusions on the outer portion of the seat 20, as crimping the inner wall towards the seat places tension on the seat and placing the protrusion on the bottom the requires force to be applied to the top surface, or sealing surface of the seat. In another embodiment, the edge or protrusion 55 is forced into the valve seat recess 22 wherein a circumferential, or partial circumferential, indentation (not shown) is located along the valve body side wall to receive the edge or protrusion. An adequate seal may not be formed if the seal is not circumferential. In such cases, an additional sealing mechanism can be used, such as a thin polymeric layer on one or more surfaces of the seat. In another embodiment, the edge or protrusion 55 is located on a valve body wall, such as the outer wall 28 and digs into the seat to secure and seal the seat in the recess 22.

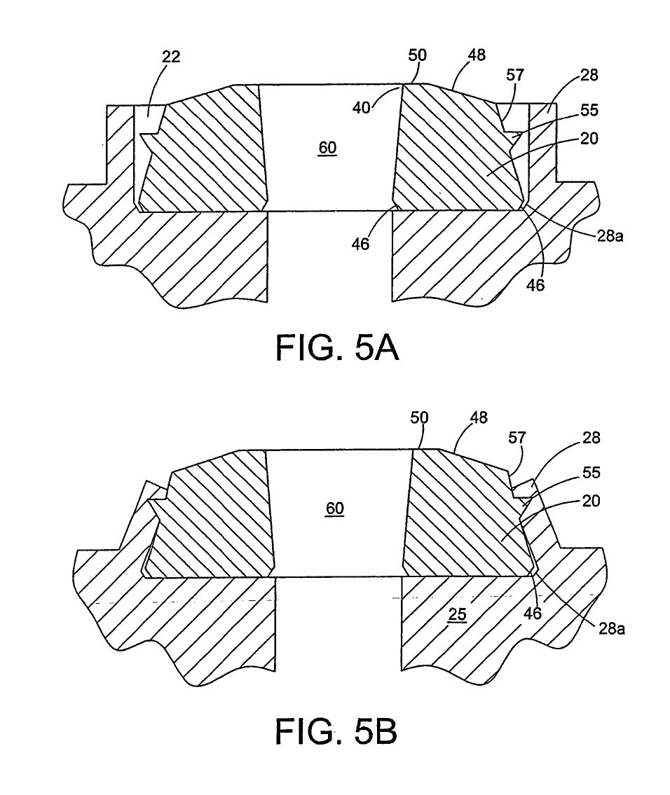

In another embodiment of the present invention, the inner wall 26 can be removed, and the valve seat 20 can be secured to the outer wall 28 by driving protrusion 55 into the surface of the outer wall 28. FIGS. 5A-5B show the staking of the valve seat 20 employing only the outer stale 28. When the outer wall 28 is crimped downward toward the valve seat 20, edge 55 digs into the stake, thereby securing the seat within the valve seat recess 22. The inner portion of the seat is thus flush with the fluid passageway at the point of connection. As such, the inner portion of the seat forms a continuous flow path with the fluid passageway. This embodiment provides the advantage of moving the sealing surface 50 of the valve seat 20 inward toward the flow passageway 60. By moving the sealing surface 50 closer to the flow passageway 60, the seal, i.e. the circumferential contact between the sealing surface 50 and the diaphragm 16, is smaller, perhaps forty percent of the seal otherwise required. With a reduced seal area, the actuator 18 needs to produce less force to provide the seal, thereby increasing the cycle life of the valve. In order to further minimize the seal circumference, the inner portion of the seal can lie along the same axis as the fluid passageway, thereby forming a straight continuous flow path.

In another embodiment of the present invention, the valve seat, or portions of the valve seat, can be hardened. For example, the sealing surface 50 can be case hardened to provide a seal with the diaphragm 16. By hardening the sealing surface 50, the valve may have an improved leak rate and will last additional cycles. This is because the seat will be harder than the diaphragm, and as such, will be less likely to deform from the force asserted by the diaphragm. With the seat being harder than the diaphragm, the diaphragm will wear prior to the seat. This can be advantageous for most valve assemblies as the diaphragm is earlier to replace than the seat. Furthermore, typical valves require a number of cycles in order to conform the seal surface and diaphragm surface to each other to provide for the valve seal. By hardening the sealing surface 50, less cycles will be required in order to provide the valve seal.

In one embodiment, the diaphragm is made from Elgiloy™, which has a hardness of about 50 Rockwell C. This embodiment is preferred as it provides the greatest cycle life for the diaphragm. In this embodiment, the seat, or a portion thereof, can be hardened so that it is harder than the diaphragm, and preferably the seat is hardened to at least 55 Rockwell C. In other embodiments, the edge or protrusion 55 of the valve seat 20 can be hardened thereby making it easier to dig the edge into the outer wall 28.

Methods and examples of metal hardening procedures are disclosed in commonly assigned, U.S. Pat. Nos. 6,093,303 issued Jul. 25, 2000 for LOW TEMPERATURE CASE HARDENING PROCESSES; U.S. Pat. Nos. 6,165,597 issued on Dec. 26, 2000 for SELECTIVE CASE HARDENING PROCESSES AT LOW TEMPERATURE; and U.S. Pat. Nos. 6,461,448 issued on Oct. 8, 2002 for LOW TEMPERATURE CASE HARDENING PROCESSES, and commonly assigned, co-pending U.S. patent application No. 09/494,093 filed on Jan. 28, 2000 for MODIFIED LOW TEMPERATURE CASE HARDENING PROCESS, which are hereby incorporated by reference in their entirety. Although the method of hardening described in the above-referenced patents is the preferred method, one skilled in the art should appreciate that other methods of case hardening, or carburization, such as, for example, nitriding, can be used to achieve similar results. Each of these processes can be used to case harden, selectively case harden or through harden the seat.

In addition to the hardening methods mentioned above, other hardening methods can be used. Work hardening and roll hardening are some examples of other standard hardening techniques. It may be difficult to achieve the desired hardness level using these standard techniques. However, the seat may be partially work hardened and partially case hardened to achieve the desired seat hardness. Alternatively, the diaphragm could be made of a softer material, thereby allowing use of some of these other hardening techniques. As still another option, the seat can be made from a harder material, such as, for example, a ceramic or crystalline structure, such as sapphire, alumina, or zirconia, or other harder metals, such as cobalt-based alloys or other super-alloys. Yet another alternative would be to coat the metal seat with a hard coating, such as a titanium nitride coating.

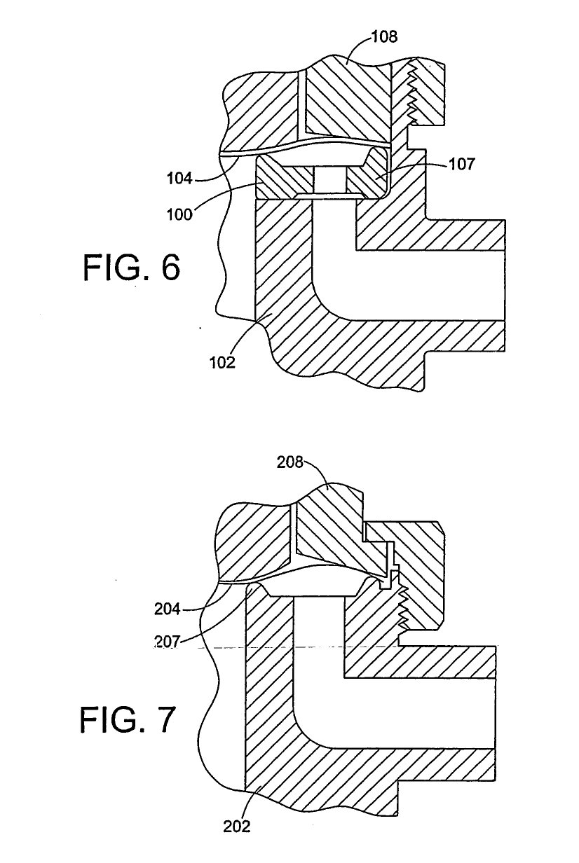

The present invention can find use in other valve assemblies that employ plastic seats, wherein the plastic seat is replaced by a hardened metal seat. For example, a removable plastic is disclosed in commonly assigned, U.S. Pat. No. 5,215,286 issued Jun. 1, 1993 for HIGH PRESSURE DIAPHRAGM VALVE, which is hereby incorporated by reference. Using the invention as disclosed in this application, FIG. 6 illustrates a removable metal seat 100 inserted into a valve body 102. The diaphragm 104 seals against seat surface 106, while the body seal is formed between the diaphragm and the outer portion 107 of the seat 100. The diaphragm 104 is held in place by the clamping force exerted by the bonnet 108. The seat is hardened, using the methods disclosed above, such that it is harder than the diaphragm. As such, a strong seal is provided between the diaphragm and the seat. In FIG. 7, the valve seat is integrally formed. The diaphragm 204 seals against hardened metal seat surface 207 to seal the flow path. The diaphragm 204 is also secured between the bonnet 208 and the valve body 202, a portion of which can be hardened.

Another embodiment of the present invention employs a coated or partially coated valve seat. The seal includes a layer of soft polymeric material molded or deposited on the seal or select surfaces of the seal. The coating can be any suitable plastic, such as, for example, polyfluoroamide or polychloro-trifluoro-ethene. The plastic coating can be used to provide a strong seal between the seat and either the diaphragm or the valve body. In general, a metal seat is used under conditions a plastic seat would not work, such as high temperature. By using only a small amount of plastic coating, the rated temperature for a valve assembly may increase as the valve seat will continue to function until the plastic is thermally degraded. A thin plastic coating can be placed between the seat, either on the backside or bottom, to provide a good body seal. A thin plastic coating can be place on the seat seal surface to provide a good seal against the diaphragm. The thin coating of plastic may provide improved resistance to chemical swelling, improve resistance to seat deformation, as compared to an all-plastic seat, and improved sealing between metal parts. As another alternative, the seat can be primarily plastic, and a portion can be a hardened metal. This embodiment would have nearly the same thermal restrictions as an all-plastic seat, however may provide improved chemical resistance.

Although the invention has been disclosed and described with respect to certain preferred embodiments, certain variations and modifications may occur to those skilled in the art upon reading this specification. Any such variations and modifications are within the purview of the invention notwithstanding the defining limitations of the accompanying claims and equivalents thereof Accordingly, departures may be made from such details without departing from the spirit or scope of the applicant's general inventive concept.

1. A diaphragm valve comprising:
a fluid passageway passing through a valve body;
a diaphragm for sealing said fluid passageway; and
a valve seat, wherein said valve seat includes one or more protrusions wherein a portion of the valve body is crimped against said one or more protrusions to secure the valve seat to the valve body.

2. The diaphragm valve of claim 1, wherein said valve seat is an insert formed separate from said valve body.

3. The diaphragm valve of claim 1, wherein said valve seat is inserted within a valve seat recess.

4. The diaphragm valve of claim 1, wherein said valve is inserted within a valve seat recess formed by an outer body wall and open to said fluid passageway.

5. The diaphragm valve of claim 4, wherein said open side of said valve seat is flush with said fluid passageway at a point where the valve seat and the valve body meet.

6. The diaphragm valve of claim 1, wherein said valve seat includes a raised sealing surface that generally matches the contour of a surface on said diaphragm.

7. The diaphragm valve of claim 1, wherein at least some portion of said valve seat is case hardened.

8. The diaphragm valve of claim 7, wherein said hardened portion of said valve seat is substantially free from carbides.

9. The diaphragm valve of claim 1, wherein the valve seat is greater than 55 Rockwell C.

10. The diaphragm valve of claim 1, wherein the valve seat is harder than the diaphragm.

11. The diaphragm valve of claim 1, wherein at least one of said one or more protrusions is on an outer edge of said metal valve seat.

12. The diaphragm valve of claim 1, wherein at least one said one or more protrusions is angled with respect to a center radius of the metal valve seat.

13. The diaphragm valve of claim 1, wherein at least one of said one or more protrusions is angled away from a seat bottom portion.

14. The diaphragm valve of claim 1, wherein said valve seat is metal.

15. The diaphragm valve of claim 1, wherein at least some portion of said valve seat is hardened.

16. The diaphragm valve of claim 1 further comprising a thin layer of polymeric material covering one or more surfaces of said valve seat.

17. A diaphragm valve comprising:
a fluid passageway disposed within a valve body;
a diaphragm for sealing said fluid passageway; and
a valve seat insert comprising an inner circumferential surface, wherein said inner circumferential surface is substantially flush with said fluid passageway at a point where the valve seat and valve body meet.

18. The diaphragm valve of claim 17, wherein said valve seat insert inner circumferential surface forms a continuous flow path with said fluid passageway.

19. The diaphragm valve of claim 17, wherein said valve seat insert inner circumferential surface is formed along the same axis as the fluid passageway.

20. The diaphragm valve of claim 17, wherein said valve seat insert further comprises a seat sealing surface, wherein said sealing surface is located proximate to said fluid passageway.

21. The diaphragm valve of claim 17, wherein said valve seat insert further comprises one or more protrusions for securing the valve seat to the valve body.

22. The diaphragm valve of claim 21, wherein said one or more protrusions form a seal surface between said valve seat and the valve body.

23. The diaphragm valve of claim 17, wherein at least some portion of the valve seat is hardened.

24. The diaphragm valve of claim 17, wherein at least some portion of the valve is case hardened.

25. (canceled)

26. The diaphragm valve of claim 17, wherein the valve seat is harder than the diaphragm.

27. A valve seat comprising:
a generally annular seat body; and
one or more protrusions located on one or more surfaces of said seat body, wherein said one or more protrusions are used to secure and seal the valve seat to a valve body by crimping a portion of the valve body against said one or more protrusions.

28. The valve seat of claim 27, further comprising a sealing surface associated with said seat body.

29. The valve seat of claim 28, wherein said sealing surface is located along a top portion of the seat body, proximate to an inner surface of said valve seat.

30. The valve seat of claim 27, wherein at least some portion of the valve seat is hardened.

31. The valve seat of claim 27, wherein at least some portion of the valve seat is case hardened.

32. The valve seat of claim 27, wherein said valve seat is harder than a diaphragm with which it is used.

33. The valve seat of claim 27, wherein said valve seat is greater than 55 Rockwell C.

34. The valve seat of claim 27, wherein at least one of said one or more protrusions is angled with respect to the center radius of said valve seat.

35. A valve seat for a diaphragm valve, wherein at least some portion of the valve seat is hardened to greater than 55 Rockwell C.

36. The valve seat of claim 35, wherein said seat is case hardened.

37. The valve seat of claim 35 further comprising one or more protrusions located on one or more surfaces of said valve seat.

38. The valve seat of claim 35 further comprising a thin layer of polymeric material applied to one or more surfaces of said valve seat.

39. The valve seat of claim 35 wherein said valve seat is metal or ceramic.

40. The valve seat of claim 35, wherein said valve seat includes a sealing surface, said sealing surface being selectively case hardened.

41. (canceled)

42. (canceled)

43. A diaphragm valve comprising:
a fluid passageway disposed within a valve body;
a metal diaphragm for sealing said fluid passageway; and
a valve seat, wherein said valve seat is harder than said metal diaphragm.

44. The diaphragm valve of claim 43, wherein said valve seat is an insert.

45. The diaphragm valve of claim 43, wherein said diaphragm is comprised of Elgiloy™.

46. The diaphragm valve of claim 43, wherein said valve seat is greater than 55 Rockwell C.

47. The diaphragm valve of claim 43, wherein said valve seat is metal.

48. The diaphragm valve of claim 43, wherein said valve seat is ceramic.

49. The diaphragm valve of claim 43, wherein at least some portion of the valve seat is hardened.

50. The diaphragm valve of claim 43, wherein at least some portion of the valve is case hardened.

51. The diaphragm valve of claim 43, wherein at least some portion of the valve is carburized.

52. The diaphragm valve of claim wherein said valve seat further includes a thin layer of polymeric material on one or more surfaces of said valve seat.

53. The diaphragm valve of claim 43, wherein said valve seat further comprises one or more protrusions extending from one or more surfaces of said valve seat.

54. The diaphragm valve of claim 43, wherein said valve seat comprises one or more protrusions that are angled with respect to the center radius of said valve seat.

55. The diaphragm valve of claim 43, wherein said valve seat is harder than said valve body.

56. The diaphragm valve of claim 43, wherein a valve seat comprising an inner circumferential surface, wherein said inner circumferential surface is flush with said fluid passageway at a point where the valve seat and valve body meet.

57. The diaphragm valve of claim 56, wherein said valve seat inner circumferential surface forms a continuous flow path with said fluid passageway.

58. The diaphragm valve of claim 56, wherein said valve seat inner circumferential surface is formed along the same axis as the fluid passageway.

59. The diaphragm valve of claim 56, wherein said valve seat further comprises a seat sealing surface, wherein said sealing surface is located proximate to said fluid passageway.

60. A method of staking a valve seat insert comprising the steps of:
inserting a valve seat insert into a recess formed in a valve body;
providing one or more protrusions on one or more surfaces of said valve seat insert; and
digging said one or more protrusions into at least one side wall of said valve body.

61. The method of claim 60, wherein said valve seat insert is metal.

62. The method of claim 60, further comprising the step of hardening at least some portion of said valve seat insert.

63. The method of claim 60 wherein said valve seat insert is harder than a diaphragm with which it is used.

64. A hardened metal valve seat insert, wherein said valve seat insert is removable.

65. A valve seat comprising:
a) a generally annular seat body made from stainless steel or ceramic material;
b) a thin layer of polymeric material applied to one or more surfaces of the seat body.

66. The valve seat of claim 65 wherein the seat body includes a sealing surface and the polymeric material is applied to the sealing surface.

67. A diaphragm valve comprising:
a valve body that includes a fluid passageway;
a diaphragm for sealing said fluid passageway; and
a valve seat coated by a thin layer of polymeric material.

68. The diaphragm valve of claim 67 wherein a portion of the valve body is crimped against the valve seat to secure the valve seat to the valve body.

69. The diaphragm valve of claim 67 wherein the valve seat includes a protrusion that a portion of the valve body is crimped against to secure the valve seat to the valve body.

70. The diaphragm valve of claim 67 wherein an inner circumferential surface of the valve seat is substantially flush with said fluid passageway at a point where the valve seat and the body meet.

71. The diaphragm valve of claim 67 wherein the valve seat is made from a non-porous material.

72. The diaphragm valve of claim 67 wherein the valve seat is made from stainless steel.

73. The diaphragm valve of claim 67 wherein the thin layer of polymeric material is molded onto the valve seat.
